(19) United States
(12) Patent Application Publication
(10) Pub. No.: US 2024/0220836 A1
(43) Pub. Date: Jul. 4, 2024

(54) Measuring Quantum Gate Fidelity Relative to a Unitary

(71) Applicant: Google LLC, Mountain View, CA (US)

(72) Inventors: Dripto Mazumdar Debroy, Los Angeles, CA (US); Vadim Smelyanskiy, Mountain View, CA (US); Wojciech Jerzy Mruczkiewicz, Zürich (CH); Zhang Jiang, El Segundo, CA (US); Élie Genois, Sherbrooke (CA); Jonathan Arthur Gross, Venice, CA (US)

(21) Appl. No.: 18/401,103

(22) Filed: Dec. 29, 2023

Related U.S. Application Data
(60) Provisional application No. 63/436,221, filed on Dec. 30, 2022.

(51) Int. Cl. G06N 10/20; G06N 10/40; G06N 10/70

(52) U.S. Cl. CPC G06N 10/20; G06N 10/40; G06N 10/70

(57) ABSTRACT

Systems and methods for quantum computing devices are provided. In one example, a method may include preparing one or more qubits in a selected initial state of a set of initial states. The method may include implementing a first quantum circuit for n repetitions on the one or more qubits, the first quantum circuit comprising one or more quantum gates. The method may include implementing a second quantum circuit to map a state of the one or more qubits towards a target state, the second quantum circuit based on a unitary associated with the first quantum circuit. The method may include performing a measurement of the one or more qubits. The method may include determining a fidelity between the first quantum circuit and the unitary based at least in part on the measurement of the one or more qubits.

### PRIORITY CLAIM

The present application claims the benefit of priority of U.S. Provisional Application Ser. No. 63/436,221, titled “Measuring Quantum Gate Fidelity Relative to a Unitary,” filed on Dec. 30, 2022, which is incorporated herein by reference.

### FIELD

The present disclosure relates generally to quantum computing systems and more particularly to characterizing and reducing errors in operations (e.g., quantum gates) implemented by quantum computing systems.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0,” quantum computing systems may manipulate information using quantum bits (“qubits”). A qubit may refer to a quantum device that enables the superposition of multiple states, e.g., data in both the “0” and “1” state, and/or to the superposition of data, itself, in the multiple states. In accordance with conventional terminology, the superposition of a “0” and “1” state in a quantum system may be represented, e.g., as a |0 [symbol] +b|1 [symbol] The “0” and “1” states of a digital computer are analogous to the |0 [symbol] and |1 [symbol] basis states, respectively of a qubit.

### SUMMARY

Aspects and advantages of embodiments of the present disclosure will be set forth in part in the following description, or may be learned from the description, or may be learned through practice of the embodiments.

One example aspect of the present disclosure is directed to a method. The method may include preparing, by one or more quantum computing devices, one or more qubits in a selected initial state of a set of initial states. The method may include implementing, by the one or more quantum computing devices, a first quantum circuit for n repetitions on the one or more qubits, the first quantum circuit comprising one or more quantum gates. The method may include implementing, by the one or more quantum computing devices, a second quantum circuit to map a state of the one or more qubits towards a target state, the second quantum circuit based on a unitary associated with the first quantum circuit. The method may include performing, by the one or more quantum computing devices, a measurement of the one or more qubits. The method may include determining, by the one or more quantum computing devices, a fidelity between the first quantum circuit and the unitary based at least in part on the measurement of the one or more qubits.

Other aspects of the present disclosure are directed to various systems, methods, apparatuses, non-transitory computer-readable media, computer-readable instructions, and computing devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example quantum computing system according to example embodiments of the present disclosure;

FIG. 2 depicts a flow chart of an example method according to example embodiments of the present disclosure;

FIG. 3 depicts a representation of an example 2-design according to example embodiments of the present disclosure;

FIG. 4 depicts an example circuit for determining a fidelity according to example embodiments of the present disclosure;

FIG. 5 depicts an example circuit for mapping qubit(s) toward a target state according to example embodiments of the present disclosure;

FIG. 6 depicts a flow diagram of an example method according to example embodiments of the present disclosure;

FIG. 7 depicts example fidelity data according to example embodiments of the present disclosure; and

FIG. 8 depicts example fidelity data according to example embodiments of the present disclosure.

### DETAILED DESCRIPTION

Example aspects of the present disclosure are directed to characterizing and reducing errors in implementation of operations (e.g., quantum gates) in a quantum computing system. Reliably understanding the structure of noise in quantum processors may be beneficial in the advancement of quantum computing devices. There are a variety of characterization methods available to quantify and/or validate the performance of quantum operations, such as state preparation of qubits, single qubit quantum gates, composite quantum gates (e.g., quantum gates that act on two or more qubits), measurement, and reset. For instance, characterization methods may include randomized benchmarking (RB), cross-entropy benchmarking (XEB), unitary tomography (UT), quantum process tomography (QPT), gate set tomography (GST), and direct fidelity estimation (DFE).

As quantum computer systems scale, complex intercomponent interactions arise, such as control crosstalk or gate bleeding, which may make the performance of a given quantum operation highly context-dependent. To that end, there is a growing need for methods which account for such non-local effects when characterizing quantum operations and system dynamics.

Aspects of the present disclosure are directed to systems and methods for characterizing quantum operations that provide for the determination of a fidelity between an experimentally implemented quantum operation and a unitary. The systems and methods according to aspects of the present disclosure also provide for the extraction of coherent and incoherent error information from the fidelity data while remaining fast, reliable, and robust to state preparation and measurement (SPAM) errors. Coherent errors are errors that apply a reversable (but potentially unknown) transformation. Incoherent errors are errors that cause decoherence of the quantum state and are irreversible.

In some examples, the systems and methods of the present disclosure provide for the determination of an average quantum gate fidelity for n repetitions of a quantum operation of interest using a reasonable number of experiments while matching the quantum circuit context (e.g., both spatial context and temporal context) intended for the quantum operation. Spatial context can include, for example, operations that are applied to qubits in spatial proximity to the qubit(s) on which the quantum operation is performed, or other environmental properties associated with a spatial environment of the operation of interest. Temporal context can include, for example, operations that are applied close in time to the operation of interest (e.g., before and/or after the operation of interest, such as quantum gate(s) or operation(s) immediately before and/or immediately after the operation of interest) or other temporal effects or temporal correlations (e.g., residual pulse tails, etc.).

In one example, the systems and methods may include preparing one or more qubits in a selected initial state of a set of initial states. The set of initial states may approximate a Haar random state. The set of initial states may be associated with a 2-design, such as a symmetric, informationally complete, positive operator-valued measure 2-design.

The systems and methods may include implementing a first quantum circuit for n repetitions on the one or more qubits. The first quantum circuit may have one or more quantum gates of interest (e.g., the quantum gates/operations that are desired to be characterized). In some examples, implementing the first quantum circuit may include implementing one or more contextual quantum gates on one or more contextual qubits in spatial proximity to the one or more qubits. In some examples, implementing the first quantum circuit may include implementing one or more contextual quantum gates in temporal proximity to the first quantum circuit.

After the n repetitions of the first quantum circuit, the systems and methods may implement a second quantum circuit to map a state of the one or more qubits towards a target state (e.g., |00 [symbol] in an example where the one or more qubits are two qubits). The second quantum circuit may be based on a unitary used to characterize the first quantum circuit. This unitary may be referred to as the fiducial unitary. In some examples, the fiducial unitary may be an ideal unitary associated with the first quantum circuit. In some examples, the fiducial unitary may be a characterization unitary (e.g., a derived unitary) associated with the first quantum circuit. The second quantum circuit can be configured to map the one or more qubits to the target state and can include operations (e.g., quantum gates) that are determined based on the fiducial unitary. In some examples, the systems and methods may implement the second quantum circuit to map the state of the one or more qubits towards the target state in a single operation.

After implementation of the second circuit, the systems and methods may include performing a measurement of the one or more qubits. A fidelity between the first quantum circuit and the fiducial unitary may be determined based on the measurement. For instance, the fidelity between n repetitions of the first quantum circuit and the nth power of the fiducial unitary may be determined by averaging a probability of measuring the target state over the set of all of the initial states (e.g., over the states of the 2-design). The operations above may be repeated for different values of n to determine fidelity data that provides a fidelity according to aspects of the present disclosure for each value of n. The fidelity data may be analyzed to assess the fiducial unitary used to characterize the first quantum circuit. In some instances, a plurality of fiducial unitaries can be compared (e.g., in a plurality of successive tests) to assess a plurality of unitary characterization methods. In some embodiments, the systems and methods may extract coherent error information and incoherent error information from the fidelity data. As an example, the coherent error information may be extracted from linear contributions or linear behavior of the fidelity data with respect to n. The incoherent information may be extracted, for instance, from quadratic contributions or quadratic behavior of the fidelity data with respect to n.

In some instances, a context can be selected or modified based on one or more testing goals. For example, tests described above can be repeated using a plurality of contexts to quantify a plurality of respective effects of a plurality of environmental variables or error types (e.g., crosstalk, measurement-induced dephasing, etc.) on the operation of interest. In some instances, additional context (e.g., spatially proximate operations such as microwave operations, measurements on surrounding qubits, etc.) can be added to increase an error rate of a particular type (e.g., crosstalk, etc.). In some instances, a plurality of error-causing contexts can be tested in combination with a plurality of fiducial unitaries to assess a robustness of a plurality of unitary characterization methods to a plurality of error types. In some instances, additional context can be added to decrease an error rate of one or more types. For example, a temporally proximate dynamical decoupling circuit can be added between repetitions of a quantum operation of interest. Such dynamical decoupling can, for example, echo out single-qubit phase errors and mitigate low-frequency noise. Advantageously, an impact of such an error-reducing modification can in some instances be insignificant relative to one or more error channels isolated by the additional context.

Aspects of the present disclosure provide a number of technical effects and benefits. For instance, some implementations may be used to assess the performance of quantum circuits directly, while correctly capturing the impact of stray interactions, gate bleeding, and other error models that prevent isolated gate characterizations from predicting experimental performance. The systems and methods according to example aspects of the present disclosure may be in contrast with general randomized benchmarking techniques, where Haar-random circuits are used to twirl coherent errors into incoherent errors, effectively randomizing the context of the operation. The systems and methods according to example aspects of the present disclosure provide for the determination of the fidelity of quantum operations in a way that matches a target experiment in both spatial and temporal context. The fidelity may be determined to measure against various unitary characterizations, making it a useful tool when comparing the efficacy of competing characterization methods. In some examples, aspects of the present disclosure may allow for the separation of contributions to error behavior from coherent and incoherent sources. In some instances, aspects of the present disclosure may allow for more accurate fidelity estimation than prior methods (e.g., interleaved randomized benchmarking), while requiring significantly fewer experimental resources.

As used herein, the use of the term “about” or “approximately” in conjunction with a stated numerical value is intended to refer to within 10% of the stated numerical value. As used herein, “near maximum” refers to within 10% of a maximum. As used herein, “near minimum” refers to within 10% of a minimum.

With reference now to the FIGS., example embodiments of the present disclosure will be discussed in further detail.

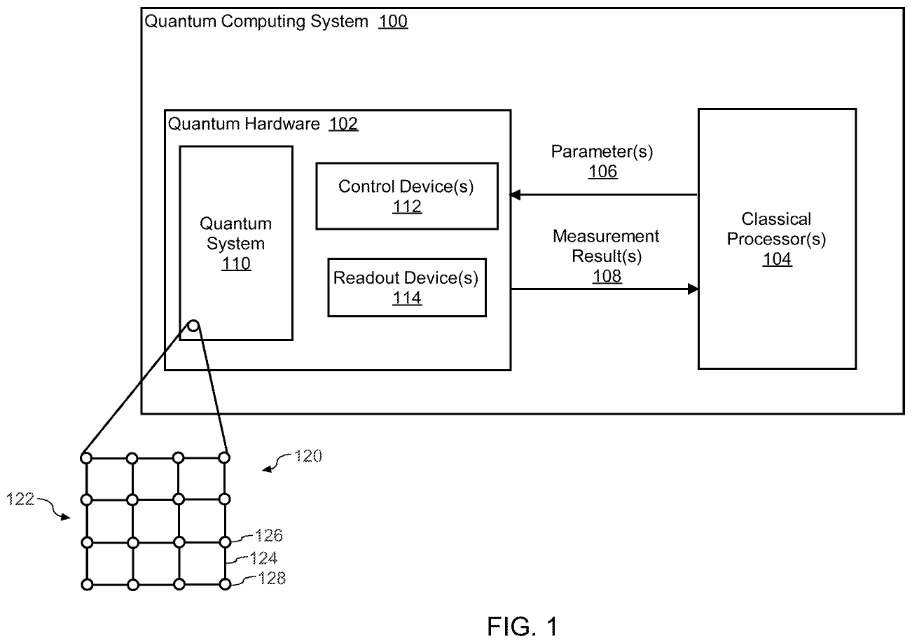

FIG. 1 depicts an example quantum computing system 100. The system 100 is an example of a system of one or more classical computers and/or quantum computing devices in one or more locations, in which the systems, components, and techniques described below may be implemented. Those of ordinary skill in the art, using the disclosures provided herein, will understand that other quantum computing devices or systems may be used without deviating from the scope of the present disclosure.

The system 100 includes quantum hardware 102 in data communication with one or more classical processors 104. The classical processors 104 may be configured to execute computer-readable instructions stored in one or more memory devices to perform operations, such as any of the operations described herein. The quantum hardware 102 includes components for performing quantum computation. For example, the quantum hardware 102 includes a quantum system 110, control device(s) 112, and readout device(s) 114 (e.g., readout resonator(s)). The quantum system 110 may include one or more multi-level quantum subsystems, such as a register of qubits (e.g., qubits 120). In some implementations, the multi-level quantum subsystems may include superconducting qubits, such as flux qubits, charge qubits, transmon qubits, gmon qubits, etc.

The type of multi-level quantum subsystems that the system 100 utilizes may vary. For example, in some cases it may be convenient to include one or more readout device(s) 114 attached to one or more superconducting qubits, e.g., transmon, flux, gmon, xmon, or other qubits. In other cases, ion traps, photonic devices or superconducting cavities (e.g., with which states may be prepared without requiring qubits) may be used. Further examples of realizations of multi-level quantum subsystems include fluxmon qubits, silicon quantum dots or phosphorus impurity qubits.

Quantum circuits may be constructed and applied to the register of qubits included in the quantum system 110 via multiple control lines that are coupled to one or more control devices 112. Example control devices 112 that operate on the register of qubits may be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 112 may be configured to operate on the quantum system 110 through one or more respective control parameters (e.g., one or more physical control parameters). For example, in some implementations, the multi-level quantum subsystems may be superconducting qubits and the control devices 112 may be configured to provide control pulses to control lines to generate magnetic fields to adjust the frequency of the qubits.

The quantum hardware 102 may further include readout devices 114 (e.g., readout resonators). Measurement results 108 obtained via measurement devices may be provided to the classical processors 104 for processing and analyzing. In some implementations, the quantum hardware 102 may include a quantum circuit and the control device(s) 112 and readout devices(s) 114 may implement one or more quantum logic gates that operate on the quantum system 102 through physical control parameters (e.g., microwave pulses) that are sent through wires included in the quantum hardware 102. Further examples of control devices include arbitrary waveform generators, wherein a DAC (digital to analog converter) creates the signal.

The readout device(s) 114 may be configured to perform quantum measurements on the quantum system 110 and send measurement results 108 to the classical processors 104. In addition, the quantum hardware 102 may be configured to receive data specifying physical control qubit parameter values 106 from the classical processors 104. The quantum hardware 102 may use the received physical control qubit parameter values 106 to update the action of the control device(s) 112 and readout devices(s) 114 on the quantum system 110. For example, the quantum hardware 102 may receive data specifying new values representing voltage strengths of one or more DACs included in the control devices 112 and may update the action of the DACs on the quantum system 110 accordingly. The classical processors 104 may be configured to initialize the quantum system 110 in an initial quantum state, e.g., by sending data to the quantum hardware 102 specifying an initial set of parameters 106.

In some implementations, the readout device(s) 114 may take advantage of a difference in the impedance for the |0 [symbol] and |1 [symbol] states of an element of the quantum system, such as a qubit, to measure the state of the element (e.g., the qubit). For example, the resonance frequency of a readout resonator may take on different values when a qubit is in the state |0 [symbol] or the state |1 [symbol] , due to the nonlinearity of the qubit. Therefore, a microwave pulse reflected from the readout device 114 carries an amplitude and phase shift that depend on the qubit state. In some implementations, a Purcell filter may be used in conjunction with the readout device(s) 114 to impede microwave propagation at the qubit frequency.

In some embodiments, the quantum system 110 may include a plurality of qubits 120 arranged, for instance, in a two-dimensional grid 122. For clarity, the two-dimensional grid 122 depicted in FIG. 1 includes 4×4 qubits, however in some implementations the system 110 may include a smaller or a larger number of qubits. In some embodiments, the multiple qubits 120 may interact with each other through multiple qubit couplers, e.g., qubit coupler 124. The qubit couplers may define nearest neighbor interactions between the multiple qubits 120. In some implementations, the strengths of the multiple qubit couplers are tunable parameters. In some cases, the multiple qubit couplers included in the quantum computing system 100 may be couplers with a fixed coupling strength.

In some implementations, the multiple qubits 120 may include data qubits, such as qubit 126 and measurement qubits, such as qubit 128. A data qubit is a qubit that participates in a computation being performed by the system 100. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

In some implementations, each qubit in the multiple qubits 120 may be operated using respective operating frequencies, such as an idling frequency and/or an interaction frequency(s) and/or readout frequency and/or reset frequency. The operating frequencies may vary from qubit to qubit. For instance, each qubit may idle at a different operating frequency. The operating frequencies for the qubits 120 may be chosen before a computation is performed.

FIG. 1 depicts one example quantum computing system that may be used to implement the methods and operations according to example aspects of the present disclosure. Other quantum computing systems may be used without deviating from the scope of the present disclosure.

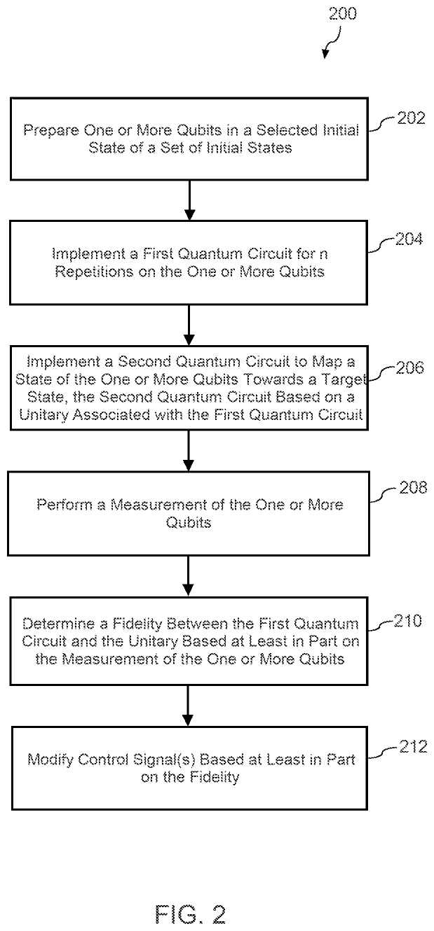

FIG. 2 depicts a flow diagram of an example method 200 according to example embodiments of the present disclosure. The method 200 may be implemented using any suitable classical and/or quantum computing system, such as the quantum computing system 100 of FIG. 1. FIG. 2 depicts operations performed in a particular order for purposes of illustration and discussion. Those of ordinary skill in the art, using the disclosures provided herein, will understand that the operations of any of the methods described herein may be rearranged, adapted, expanded, include steps not illustrated, and/or modified in various ways without deviating from the scope of the present disclosure.

At 202, the method may include preparing one or more qubits in a selected initial state of a set of initial states. The set of initial states, in some embodiments, may be a 2-design to approximate a Haar random state. The 2-design may be a symmetric, informationally complete, positive operator-valued measure (SIC-POVM). This may be an ensemble of d² pure states |ψ [symbol] which satisfy the condition:

$$\vert {ψ}_{i} \vert {ψ}_{j} \vert = \{ \begin{matrix}1 & i = j \\ \frac{1}{\sqrt{d + 1}} & i \neq j\end{matrix}$$

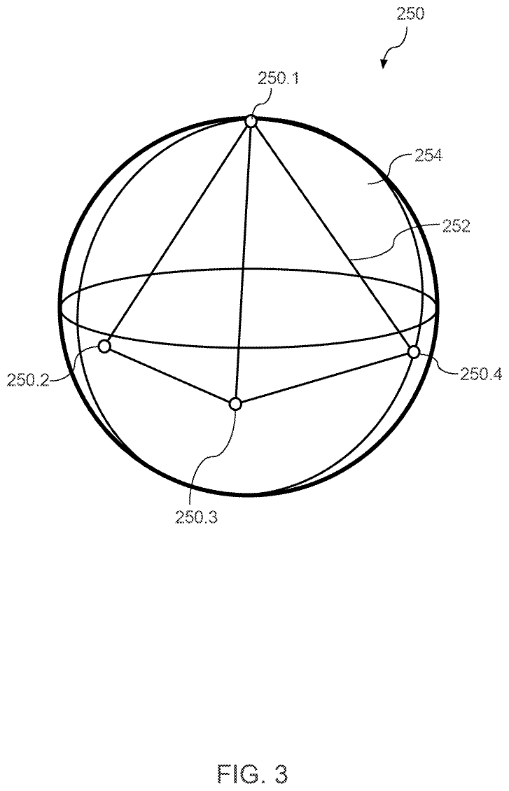

A representation of an example 2-design 250 is depicted in FIG. 3. The 2-design 250 may be created using the states 250.1, 250.2, 250.3, 250.4, . . . at the corners of a tetrahedron 252 inscribed in a Bloch sphere 254 representation of qubit. Other example sets of initial states may be used without deviating from the scope of the present disclosure.

At 204, the method 200 may include implementing a first quantum circuit for n repetitions on the one or more qubits. The first quantum circuit may implement one or more quantum operations (e.g., quantum gates) desired to be characterized. In some examples, implementing the first quantum circuit may include implementing one or more contextual quantum gates on one or more contextual qubits in spatial proximity to the one or more qubits. In some examples, implementing the first quantum circuit may include implementing one or more contextual quantum gates in temporal proximity to the first quantum circuit.

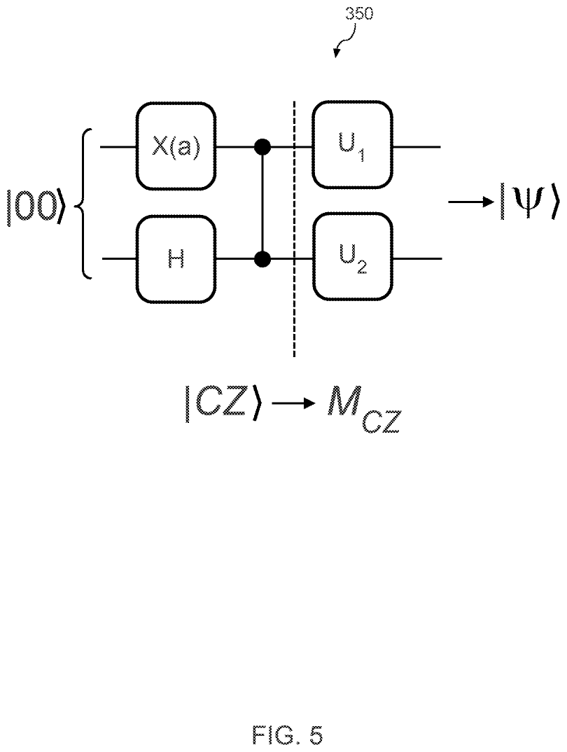

At 206 the method 200 may include implementing a second quantum circuit to map a state of the one or more qubits toward a target state, such as state |00 [symbol] in the example of a quantum circuit acting on two qubits. The mapping to the target state may be based on the fiducial unitary associated with the first quantum circuit. For instance, the fiducial unitary may be configured to model the first quantum circuit (e.g., including contextual gates and contextual qubits). In some examples, the fiducial unitary may be an ideal unitary. In some examples, the fiducial unitary may be a characterized unitary derived from one or more error models and/or characterization methods. Details concerning one example quantum circuit used to map the one or more qubits to the target state is discussed with reference to FIG. 5.

Referring to FIG. 2 at 208, the method 200 may include performing a measurement of the one or more qubits. The measurement may collapse the one or more qubits into a measured state. At 210, the method 200 may include determining a fidelity (e.g., the context aware fidelity (CAFE)) between the first quantum circuit and the unitary based at least in part on the measurement of the one or more qubits. For instance, the measurement of the one or more qubits may be used to determine a probability of the measured state being the target state (e.g., |00 [symbol] in the example of a quantum circuit acting on two qubits). The probability over all the initial states of the set of initial states may be the average fidelity for the first quantum circuit.

At 212, the method 200 may include modifying one or more control signals used to implement the first quantum circuit in the quantum computing system based at least in part on the fidelity. For instance, the one or more control signals may be modified based on the fidelity to reduce the likelihood of error during implementation of the first quantum circuit (e.g., one or more quantum gates in the first quantum circuit.

A specific example of the method 200 will be discussed with reference to FIGS. 3-5 below. The specific example is discussed with implementing a first quantum circuit including one or more CZ gates for purposes of illustration and discussion. Those of ordinary skill in the art, using the disclosures provided herein, will understand that the first quantum circuit may include other types of quantum gates.

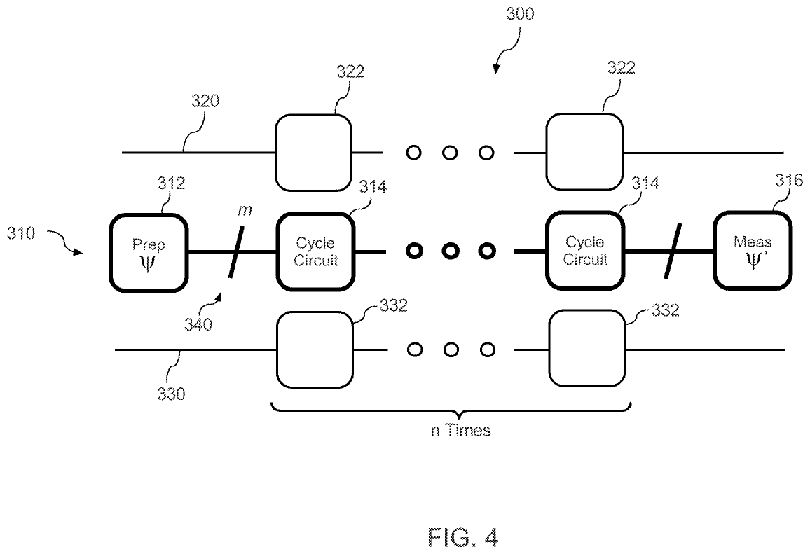

FIG. 4 depicts an example circuit diagram 300 for determining a fidelity (e.g., CAFE) according to example embodiments of the present disclosure. The circuit diagram 300 includes a circuit 310. At 312, the circuit 310 prepares a state |ψ [symbol] from an m-qubit 2-design (as discussed above). The circuit 310 implements the first quantum circuit 314 (e.g., illustrated as a cycle circuit) on the m qubits for n repetitions. This implementation includes implementing operations on neighboring contextual qubits using circuits 320 and 330. For instance, the n repetitions of the first quantum circuit 314 may include performing n repetitions of contextual quantum gate(s) 322 on contextual qubits in circuit 320 and n repetitions of contextual quantum gates(s) 332 on contextual qubits in circuit 330.

The first quantum circuit 314 may include multiple operations, such as one or more single qubit quantum gates, one or more composite quantum gates, or other operations. In some embodiments, the first quantum circuit 314 may include one or more dynamical decoupling (DD) gates. For example, in some instances, a quantum operation of interest can include a CZ gate. In such instances, dynamical decoupling can include adding an X gate to both qubits in the first quantum circuit 314. Such a DD gate can in some instances echo out single-qubit phase errors and mitigate low-frequency noise. DD gates may be robust to certain coherent error parameters. Including the DD gates in the first quantum circuit 314 may allow for focusing on error characterization that impacts performance of the quantum computing system. Inserting DD gates into the first quantum circuit 314 is one example method to facilitate separation of coherent and incoherent contributions to quantum gate errors.

In some instances, the first quantum circuit 314 may consist solely of a quantum circuit of interest operating on one or more qubits of interest, and the first quantum circuit 314 can be repeated n times with no temporally proximate quantum operations being performed on the qubits of interest between respective repetitions of the n repetitions. Such a lack of interleaved operations can, for example, reduce unwanted errors relative to interleaved randomized benchmarking (IRB), wherein single-qubit gates used by IRB to create random Clifford gates can introduce unwanted error sources from decoherence and systematic errors.

The circuit 310 may implement a second circuit 316 (e.g., measurement circuit). The second circuit 316 attempts to map the state of the qubits back to a target state (e.g., |00 [symbol] in the example of a quantum circuit acting on two qubits) using the fiducial unitary. The average gate fidelity of the first quantum circuit 314 may be found by averaging over the experiments for all initial 2-design states {ψᵢ} as set forth below:

$$= {0 …0}_{} {\{ {ψ}_{i} \}}_{}$$

More specifically, first, a state pulled from an m qubit 2-design, {ψi}, is prepared at 312. Then, the cycle circuit being characterized is applied the desired number of times n at 314. Finally, the state is mapped back to |00 [symbol] using the fiducial unitary, and then measured at 316. The fidelity between n repetitions of the applied operation and the nth power of the fiducial unitary may be found by averaging the probability of getting |00 [symbol] over all initial states.

In some instances, one or more contexts (e.g., contextual quantum gates 332, 322) can be selected or modified based on one or more testing goals. For example, a first plurality of contextual variables (e.g., quantum gates 332, 322) can be selected. The circuit 310 can prepare a state |ψ [symbol] from an m-qubit 2-design (as discussed above). The circuit 310 can implement the first quantum circuit 314 (e.g., illustrated as a cycle circuit) on the m qubits for n repetitions, subject to the first plurality of contextual variables. In some instances, for example, the circuit 300 can implement a first plurality of contextual quantum gates 322, 332 for n repetitions. The m qubits can be mapped to a target state (e.g., based on a fiducial unitary). One or more first fidelity values (e.g., fidelity relative to a characterized unitary or ideal unitary: incoherent error rate; coherent error rate; etc.) can be determined based on one or more measurements at 316. A second plurality of contextual variables can be selected; a state |ψ♭ can be prepared; the first quantum circuit 314 can be repeated for n repetitions subject to the second plurality of contextual variables; and one or more second fidelity values can be determined. In some instances, the first and second fidelity values can be compared to determine a robustness of a quantum circuit 314 or a robustness of a characterized unitary to one or more error types.

FIG. 5 depicts an example circuit 350 for mapping a plurality of qubits towards a target state (e.g., |00 [symbol] ) according to example embodiments of the present disclosure. More specifically, the circuit 350 maps |00 [symbol] to an arbitrary two-qubit state |ψ [symbol] using only one CZ operation. The overlap of any two-qubit state with the state |ψ [symbol] may be obtained by executing the inverse of this circuit 350 and reporting the probability of measuring |00 [symbol] afterwards.

More specifically, a general two-qubit target state may be characterized as follows:

$$\vert ψ 〉 = A \vert 00 〉 + B \vert 01 〉 + C \vert 10 〉 + D \vert 11 〉 , \\ {\vert A \vert}^{2} + {\vert B \vert}^{2} + {\vert C \vert}^{2} + {\vert D \vert}^{2} = 1.$$

A matrix with amplitudes of this state is provided below:

$${M}_{ψ} = [ \begin{matrix}A & B \\ C & D\end{matrix} ]$$

Singular value decomposition (SVD) of this matrix yields:

$${M}_{ψ} = {U}_{ψ} {S}_{ψ} {V}_{ψ}^{†} .$$

Considering the initial singular value, S_{ψ}⁰⁰, the level of entanglement in the target state may be quantified.

The first operation to generate the target state is to prepare a state with a matching entanglement signature. In the example where a CZ gate is used, one qubit may be put in |+ [symbol] . A Y rotation may be applied to the other qubit with angle of α=2 arccos(S_{ψ}⁰⁰). This state, labeled as |CZ [symbol] in FIG. 5 is equivalent to the final state up to single qubit rotations. To find these rotations, the SVD of the 2×2 matrix corresponding to an intermediate state below:

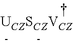

The single qubit unitary for the first qubit is given by:

$${U}_{1} = {U}_{ψ} {U}_{CZ}^{- 1}$$

The single qubit unitary for the second qubit is given by:

$${U}_{2} = {V}_{ψ} {V}_{CZ}^{- 1}$$

According to example aspects of the present disclosure, a fidelity for a quantum operation may be estimated and reported as a single number as a performance metric. This may be useful for validation and for estimating performance of various quantum algorithms, quantum circuits, and/or other operations. However, aspects of the present disclosure also provide for the extraction of the coherent and incoherent contributions to error.

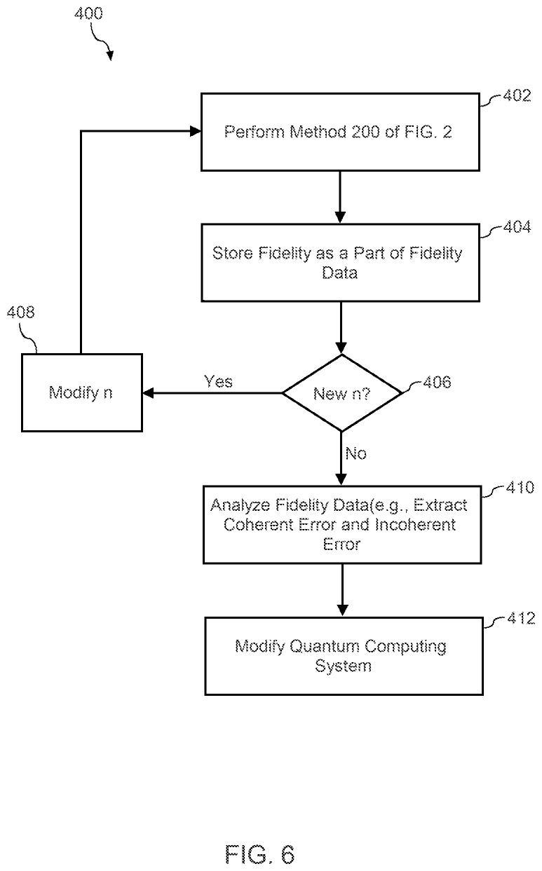

FIG. 6 depicts a flow diagram of an example method 400 according to example embodiments of the present disclosure. The method 400 may be implemented using any suitable classical and/or quantum computing system, such as the quantum computing system 100 of FIG. 1. FIG. 6 depicts operations performed in a particular order for purposes of illustration and discussion. Those of ordinary skill in the art, using the disclosures provided herein, will understand that the operations of any of the methods described herein may be rearranged, adapted, expanded, include steps not illustrated, and/or modified in various ways without deviating from the scope of the present disclosure.

At 402, the method 400 may include performing the method 200 of FIG. 2. At 404, the method 400 may include storing the fidelity as part of fidelity data. For instance, the average fidelity for a specific value of n may be stored as part of fidelity data. At 406, it may be determined whether to repeat the method 400 for a new value of n. If so, the method 400 proceeds to 408 where n is modified (e.g., incremented, changed to a different value, decremented, etc.). The method 400 may return to 402 where it repeats the method 200 of FIG. 2 for a different value of n. This may be repeated for multiple different values of n to generate the fidelity data.

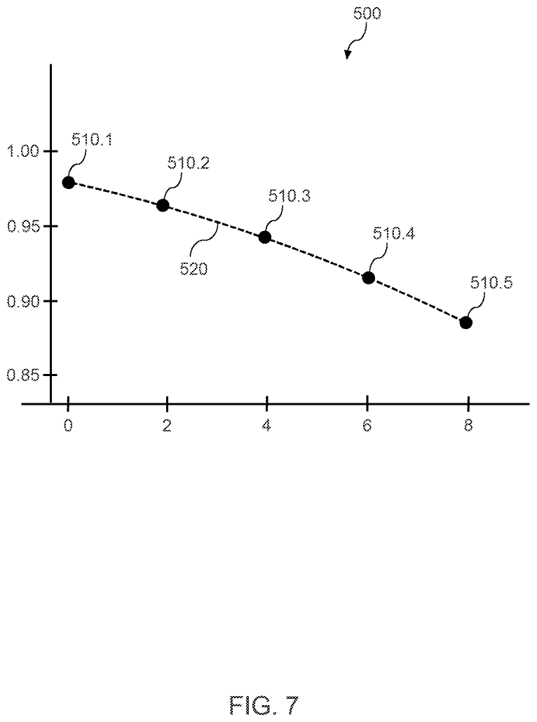

FIG. 7 depicts an example graphical representation of fidelity data 500 according to example embodiments of the present disclosure. FIG. 7 plots fidelity along the vertical axis and n (number of repetitions) along the horizontal axis. The fidelity data 500 includes fidelity 510.1 associated with n=0, fidelity 510.2 associated with n=2, fidelity 510.3 associated with n=4, fidelity 510.4 associated with n=6, fidelity 510.5 associated with n=8, and so forth. In some examples, a fidelity decay curve 520 may be fit to the fidelity data using a model. Details concerning an example model that may be used to extract and separate coherent and incoherent contributions to error is set forth in detail below.

At 410, the method 400 may include analyzing the fidelity data 410. For instance, the method 400 may include analyzing the fidelity data 410 to extract coherent error information. The method 400 may include analyzing the fidelity data 410 to extract incoherent error information (e.g., using a model or by leveraging DD pulses).

For instance, in some embodiments, a fidelity decay curve may be fitted to the fidelity data. The coherent error information may be determined from a linear contribution associated with the fidelity decay curve. The incoherent error information may be determined from a quadratic contribution associated with the fidelity decay curve.

In some instances, extracting coherent error information and incoherent error information can include fitting the fidelity data 410 to a model. One example model to fit a fidelity decay curve for a quantum circuit that is a CZ gate is described below. The unitary for the two-qubit CZ gate may be provided as follows:

$$\tilde{U} ( Δθ , Δγ , Δϕ ) = ( \begin{matrix}1 & 0 & 0 & 0 \\ 0 & {e}^{- i Δγ} cos ( Δθ ) & - {ie}^{- i Δγ} sin ( Δθ ) & 0 \\ 0 & - {ue}^{- i Δγ} sin ( Δθ ) & {e}^{- i Δγ} cos ( Δθ ) & 0 \\ 0 & 0 & 0 & - {e}^{- i ( 2 Δγ + Δϕ )}\end{matrix} )$$

A noisy quantum channel may be used to implement the first quantum circuit as described by a two-qubit depolarizing channel:

$$ε ( ρ ) = ( 1 - {depol}_{} ) \tilde{U} ρ {\tilde{U}}^{†} + {depol}_{} {I}_{d} / d$$

The two-qubit depolarizing channel outputs a totally mixed state with probability p_{depol} and otherwise applies the first quantum circuit represented by the cycle unitary. In some instances, a state preparation and measurement (SPAM) error can be modeled as an offset in the fidelity curve that is constant with respect to n, which can in some instances enable the extraction of coherent and incoherent error data that is robust to SPAM errors. With such a depolarizing channel and spam offset, a model correlating the average gate fidelity for n repetitions can be given by:

$$= \frac{1}{4} - {ϵ}_{spam} - \frac{1}{20} {( 1 - {depol}_{} )}^{n} \cdot ( 1 - {\vert 1 + 2 {e}^{- in Δγ} cos ( n Δθ ) + {e}^{- in ( 2 Δγ + Δϕ )} \vert}^{2} )$$

where ϵₛₚₐₘ represents state preparation and measurement (SPAM) error.

Using this example model, the fidelity data may be fitted to obtain fidelity in addition to incoherent error contributions ϵ_{incoh} and coherent error contributions ϵ_{coh}. To get these parameters, the following may be used:

$$1 - ℱ = 1 - \frac{{ℱ}_{1}}{( 1 - {ϵ}_{spam} )} , \\ {ϵ}_{inoch} = 1 - \frac{{ℱ}_{1} ( {depol}_{} = 0 )}{( 1 - {ϵ}_{spam} )} , \\ {ϵ}_{coh} = 1 - \frac{{ℱ}_{1} ( Δθ = Δγ = Δϕ = 0 )}{( 1 - {ϵ}_{spam} )}$$

In some embodiments, aspects of the present disclosure may include modifying the first quantum circuit (e.g., the quantum circuit being analyzed) to isolate specific errors. For instance, dynamical decoupling gates may be inserted between repetitions of the n repetitions of the first quantum circuit. This approach may be useful in characterizing coherent errors present in the first quantum circuit without requiring a full unitary tomography. In the example of a first quantum circuit that is a CZ gate, adding an X gate to both qubits in the first quantum circuit may echo out any single-qubit phase errors, in addition to mitigating low frequency noise.

Referring to FIG. 6 at 412, the method 400 may include modifying a quantum computing system based on the fidelity data. For instance, the fidelity data may be used to assess the performance of a unitary used to characterize the first quantum circuit. More specifically, in some embodiments, aspects of the present disclosure may include implementing a second quantum circuit to map the state of the one or more qubits towards the target state in a single operation. By doing all of the inversion in a single step, similar to randomized benchmarking, but using the fiducial unitary for the inversion, different unitary characterizations may be validated, while respecting the non-Clifford nature of most coherent error models. As such, the fidelity determination according to example embodiments of the present disclosure may be used to benchmark unitary characterizations, simply by changing the final measurement step and seeing which predictions most accurately map the final state back toward the target state (e.g., |00 [symbol] ).

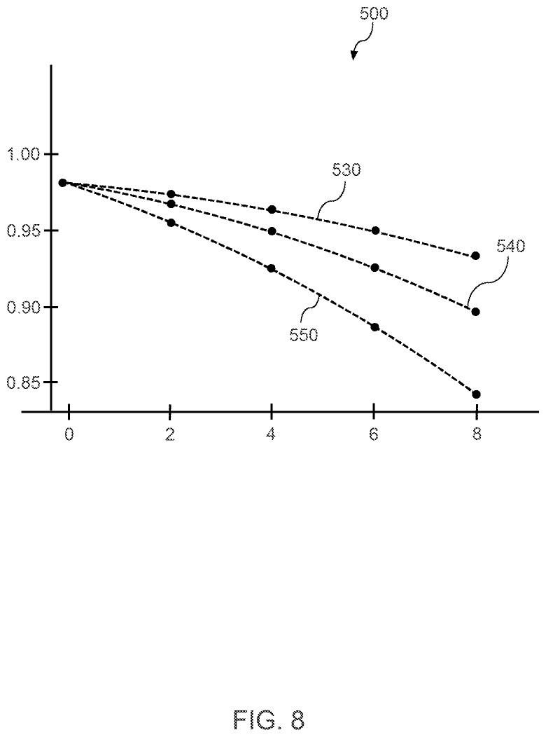

For instance, FIG. 8 depicts a plot of example fidelity data associated with three different unitary characterizations of a first quantum circuit according to example embodiments of the present disclosure. FIG. 8 plots fidelity along the vertical axis and n (number of repetitions) along the horizontal axis. Curve 530 may be associated with a first unitary characterization. Curve 540 may be associated with a second unitary characterization. Curve 550 may be associated with a third unitary characterization. The first unitary characterization may provide for isolation and measurement of different unitary parameters in, for instance, an FSIM gate. The second unitary characterization may be a unitary characterization extracted from XEB. The third unitary characterization may be an ideal unitary.

As demonstrated by FIG. 8, certain unitary characterizations are better at removing coherent error. Moreover, by increasing the amount of context around implementation of the first quantum circuit when determining fidelity (e.g., by including contextual gates and/or contextual qubits), unitary characterizations that breakdown in view of the contextual information may be used to determine the dominant effects on the quantum processor/hardware impacting algorithm performance.

In some instances, a plurality of contexts (e.g., error-increasing contextual elements) can be tested in combination with a plurality of fiducial unitaries to assess a robustness of a plurality of unitary characterization methods to a plurality of error types. For example, a first system according to FIG. 4 can be implemented using a first plurality of contextual variables (e.g., contextual quantum gates 322, 332) and a first mapping circuit (e.g., 350) configured to map m qubits to a target state based on a first fiducial unitary (e.g., characterized unitary). A second system according to FIG. 4 can be implemented using a second plurality of contextual variables and the first mapping circuit based on the first fiducial unitary. A third and fourth system according to FIG. 4 can be implemented using the first and second pluralities of contextual variables respectively, with a second mapping circuit based on a second fiducial unitary. One or more fidelities can be determined from each of the first, second, third, and fourth systems according to FIG. 4 and compared.

Based on the characterized unitary(s), error performance of a quantum computing system may be assessed. Design parameters of the quantum computing system (e.g., heat, qubit structure, control signals, hardware layout, qubit layout, etc.) may be modified based on the characterized unitary(s) to improve performance of a quantum computing system.

Implementations of the digital and/or quantum subject matter and the digital functional operations and quantum operations described in this specification may be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital and/or quantum subject matter described in this specification may be implemented as one or more digital and/or quantum computer programs, i.e., one or more modules of digital and/or quantum computer program instructions encoded on a tangible non-transitory storage medium for execution by, or to control the operation of, data processing apparatus. The digital and/or quantum computer storage medium may be a machine-readable storage device, a machine-readable storage substrate, a random or serial access memory device, one or more qubits/qubit structures, or a combination of one or more of them. Alternatively or in addition, the program instructions may be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems may include atoms, electrons, photons, ions or superconducting qubits. In many implementations the computational basis states are identified with the ground and first excited states, however it is understood that other setups where the computational states are identified with higher level excited states (e.g., qudits) are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus may also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus may optionally include, in addition to hardware, code that creates an execution environment for digital and/or quantum computer programs, e.g., code that constitutes processor firmware, a protocol stack, a database management system, an operating system, or a combination of one or more of them.

A digital computer program, which may also be referred to or described as a program, software, a software application, a module, a software module, a script, or code, may be written in any form of programming language, including compiled or interpreted languages, or declarative or procedural languages, and it may be deployed in any form, including as a stand-alone program or as a module, component, subroutine, or other unit suitable for use in a digital computing environment. A quantum computer program, which may also be referred to or described as a program, software, a software application, a module, a software module, a script, or code, may be written in any form of programming language, including compiled or interpreted languages, or declarative or procedural languages, and translated into a suitable quantum programming language, or may be written in a quantum programming language, e.g., QCL, Quipper, Cirq, etc.

A digital and/or quantum computer program may, but need not, correspond to a file in a file system. A program may be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program may be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification may be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows may also be performed by, and apparatus may also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program may be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g. photons, or combinations thereof.

Some example elements of a digital and/or quantum computer are a central processing unit for performing or executing instructions and one or more memory devices for storing instructions and digital and/or quantum data. The central processing unit and the memory may be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that may store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, may be implemented in a digital and/or quantum computer program product that includes instructions that are stored on one or more non-transitory machine-readable storage media, and that are executable on one or more digital and/or quantum processing devices. The systems described in this specification, or portions of them, may each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations may also be implemented in combination in a single implementation. Conversely, various features that are described in the context of a single implementation may also be implemented in multiple implementations separately or in any suitable sub combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems may generally be integrated together in a single software product or packaged into multiple software products.

Particular implementations of the subject matter have been described. Other implementations are within the scope of the following claims. For example, the actions recited in the claims may be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method, comprising:
preparing, by one or more quantum computing devices, one or more qubits in a selected initial state of a set of initial states;
implementing, by the one or more quantum computing devices, a first quantum circuit for n repetitions on the one or more qubits, the first quantum circuit comprising one or more quantum gates;
implementing, by the one or more quantum computing devices, a second quantum circuit to map a state of the one or more qubits towards a target state, the second quantum circuit based on a unitary associated with the first quantum circuit;
performing, by the one or more quantum computing devices, a measurement of the one or more qubits;
determining, by the one or more quantum computing devices, a fidelity between the first quantum circuit and the unitary based at least in part on the measurement of the one or more qubits.

2. The method of claim 1, wherein implementing the first quantum circuit comprises implementing one or more contextual quantum gates on one or more contextual qubits in spatial proximity to the one or more qubits.

3. The method of claim 1, wherein implementing the first quantum circuit comprises implementing one or more contextual quantum gates in temporal proximity to the first quantum circuit.

4. The method of claim 1, wherein the set of initial states approximates a Haar random state.

5. The method of claim 4, wherein the set of initial states is associated with a 2-design.

6. The method of claim 5, wherein the 2-design is a symmetric, informationally complete, positive operator-valued measure.

7. The method of claim 1, wherein determining the fidelity comprises averaging a probability of measuring the target state over the set of initial states.

8. The method of claim 1, wherein the one or more qubits comprise two qubits, and the target state is |00 [symbol] .

9. The method of claim 1, wherein implementing, by the one or more quantum computing devices, a second quantum circuit to map a state of the one or more qubits towards a target state comprises implementing, by the one or more quantum computing devices, the second quantum circuit to map the state of the one or more qubits towards the target state in a single operation.

10. The method of claim 1, wherein the method comprises repeating the method of claim 1 for a plurality of different values of n to generate fidelity data across the different values of n.

11. The method of claim 10, wherein the method comprises extracting coherent error information from the fidelity data.

12. The method of claim 10, wherein the method comprises extracting incoherent error information from the fidelity data.

13. The method of claim 1, wherein the one or more quantum gates of the first quantum circuit comprises a composite quantum gate.

14. The method of claim 1, wherein the method comprises modifying one or more control signals of the quantum computing system based at least in part on the fidelity.

15. A quantum computing system, comprising:
a plurality of qubits;
one or more control devices operable to implement one or more quantum gates on the plurality of qubits;
one or more classical or quantum processors operable to implement computer-readable instructions stored in one or more memory devices to cause the one or more classical or quantum processors to perform operations, the operations comprising:
preparing one or more qubits in a selected initial state of a set of initial states;
implementing a first quantum circuit for n repetitions on the one or more qubits, the first quantum circuit comprising one or more quantum gates;
implementing a second quantum circuit to map a state of the one or more qubits towards a target state, the second quantum circuit based on a unitary associated with the first quantum circuit;
performing a measurement of the one or more qubits; and
determining a fidelity between the first quantum circuit and the unitary based at least in part on the measurement of the one or more qubits.

16. The quantum computing system of claim 15, wherein the one or more control devices are configured to provide control signals to implement the one or more quantum gates based on the fidelity.

17. The quantum computing system of claim 15, wherein the operation of implementing the first quantum circuit comprises implementing one or more contextual quantum gates on one or more contextual qubits in spatial proximity to the one or more qubits.

18. The quantum computing system of claim 15, wherein the operation of implementing the first quantum circuit comprises implementing one or more contextual quantum gates in temporal proximity to the first quantum circuit.

19. A tangible, non-transitory computer-readable medium storing computer-readable instructions that when executed by one or more classical or quantum processors cause the one or more classical or quantum processors to perform operations, the operations comprising:
implementing a first quantum circuit for n repetitions on the one or more qubits, the first quantum circuit comprising one or more quantum gates;
implementing a second quantum circuit to map a state of the one or more qubits towards a target state, the second quantum circuit based on a unitary associated with the first quantum circuit;
performing a measurement of the one or more qubits;
determining a fidelity between the first quantum circuit and the unitary based at least in part on the measurement of the one or more qubits.

20. The tangible, non-transitory computer-readable medium of claim 19, wherein the operations further comprise modifying the unitary based at least in part on the fidelity.
